(19) United States
(12) Patent Application Publication
(10) Pub. No.: US 2011/0227971 A1
(43) Pub. Date: Sep. 22, 2011

(54) LIQUID SUPPLY APPARATUS AND METHOD, AND IMAGE RECORDING APPARATUS

(76) Inventor: Shuhei HOSHINO, Kanagawa-ken (JP)

(21) Appl. No.: 13/048,049

(22) Filed: Mar. 15, 2011

(30) Foreign Application Priority Data
Mar. 16, 2010 (JP) 2010-059587

(51) Int. Cl. B41J 29/38; F16K 31/02

(52) U.S. Cl. 347/6; 251/129.01; 137/1

(57) ABSTRACT

A liquid supply apparatus includes: a liquid supply flow channel which is connected to a liquid ejection head; a valve which is arranged in the liquid supply flow channel and opens and closes in accordance with voltage applied to an actuator of the valve; and a voltage control device which controls the voltage applied to the actuator of the valve, and gradually changes the voltage applied to the actuator of the valve from an initial voltage that is lower than a threshold voltage required for the valve to operate to a final voltage that is higher than the threshold voltage.

### BACKGROUND OF THE INVENTION

1. Field of the Invention

The present invention relates to a liquid supply apparatus, a liquid supply method and an image recording apparatus, and more particularly to technology for supplying liquid to a liquid ejection head which ejects liquid to a recording medium.

2. Description of the Related Art

Japanese Patent Application Publication No. 07-269738 discloses an electromagnetic valve driving apparatus which drives an electromagnetic valve having an actuator or a solenoid and a valve body that is driven by the solenoid, in which a current supplied to the solenoid is measured, the measured current value is averaged, and the pulse width is adjusted on the basis of the difference between the average current value and a target current value, in such a manner that the target current is obtained.

Japanese Patent Application Publication No. 2008-196596 discloses determining a position of a valve body when an electromagnetic valve is closed, and controlling the current value supplied to the solenoid on the basis of the position determination results for the valve body.

A valve (e.g., an electromagnetic valve) serves to control the flow of liquid in a flow channel, and the flow of liquid in the flow channel is switched on and off by driving the opening and closing of the valve. An operational defect may occur in the valve due to variation over time, individual differences, a fault in the drive system, and the like. If an operational defect occurs in the valve, then the control of opening and closing of the flow channel becomes instable, and the function and performance of the liquid supply apparatus decline.

If an operational defect occurs in a valve, then in the technology described in Japanese Patent Application Publication Nos. 07-269738 and 2008-196596, it is possible to move the valve body to a desired position by increasing the current supplied to the solenoid. However, if the current is increased, then the speed of opening and closing the electromagnetic valve increases in line with the increase in the current, and the pressure variation in the liquid inside the flow channel rises. If the pressure variation occurs in the flow channel that supplies liquid to a liquid ejection head (e.g., an inkjet head), then air bubbles are sucked in through the nozzles of the liquid ejection head, or the liquid overflows from the nozzles, thus giving rise to liquid ejection defects.

Moreover, in Japanese Patent Application Publication Nos. 07-269738 and 2008-196596, determination devices are required to measure the current supplied to the solenoid and to determine the position of the valve body, and therefore the apparatus is large and complicated, thus leading to increased costs. For example, the longer the liquid ejection head, the greater the number of valves and therefore the greater the number of the determination devices needed. Consequently, the determination devices become complex, and assembly errors such as wiring errors may occur.

### SUMMARY OF THE INVENTION

The present invention has been contrived in view of these circumstances, an object thereof being to provide a liquid supply apparatus, a liquid supply method and an image recording apparatus whereby the amount of pressure variation in liquid inside a flow channel caused by operation of a valve can be reduced, and operational defects of the valve arranged in the flow channel can be eliminated.

In order to attain the aforementioned object, the present invention is directed to a liquid supply apparatus, comprising: a liquid supply flow channel which is connected to a liquid ejection head; a valve which is arranged in the liquid supply flow channel and opens and closes in accordance with voltage applied to an actuator of the valve; and a voltage control device which controls the voltage applied to the actuator of the valve, and gradually changes the voltage applied to the actuator of the valve from an initial voltage that is lower than a threshold voltage required for the valve to operate to a final voltage that is higher than the threshold voltage.

According to this aspect of the present invention, pressure variation in the liquid inside the flow channel caused by the operation of the valve is suppressed, and furthermore defective operation of the valve arranged in the liquid supply flow channel can be eliminated.

In order to attain the aforementioned object, the present invention is also directed to an image recording apparatus, comprising: a liquid ejection head having nozzles which eject a liquid toward a recording medium; and the above-described liquid supply apparatus which supplies the liquid to the liquid ejection head.

In order to attain the aforementioned object, the present invention is also directed to a liquid supply apparatus, comprising: a liquid supply flow channel which is connected to a liquid ejection head; a valve which is arranged in the liquid supply flow channel and opens and closes in accordance with voltage applied to an actuator of the valve; a voltage control device which controls the voltage applied to the actuator of the valve, and gradually changes the voltage applied to the actuator of the valve from an initial voltage to a final voltage; a pressure measurement device which measures pressure of a liquid inside the liquid supply flow channel; and an adjustment device which adjusts at least one of the initial value of the voltage applied to the actuator of the valve and an amount of change per unit time of the voltage applied to the actuator of the valve, in accordance with a measurement value of the pressure obtained by the pressure measurement device.

According to this aspect of the present invention, by monitoring the pressure of the liquid inside the liquid supply flow channel and altering the initial value of the applied voltage and the amount of temporal change of the voltage, pressure variation in the liquid in the flow channel resulting from the operation of the valve is suppressed, and furthermore defective operation of the valve arranged in the liquid supply flow channel can be eliminated.

Preferably, the adjustment device decreases the amount of change per unit time of the voltage applied to the actuator of the valve when an amount of variation in the pressure before and after the voltage is applied to the actuator of the valve is larger than a prescribed value.

According to this aspect of the present invention, it is possible to decrease the amount of variation in pressure by decreasing the amount of temporal change in the applied voltage.

Preferably, the adjustment device decreases the initial voltage applied to the actuator of the valve when a time from application of the voltage to the actuator of the valve until detection of variation in the pressure is shorter than a prescribed period.

Preferably, the adjustment device decreases the initial voltage applied to the actuator of the valve when a time from application of the voltage to the actuator of the valve until detection of variation in the pressure is shorter than a prescribed period and an amount of variation in the pressure before and after the voltage is applied to the actuator of the valve is larger than a prescribed value.

According to these aspects of the present invention, it is possible to reduce the amount of variation in the pressure of the liquid by lowering the initial value of the applied voltage when the initial voltage is higher than the threshold voltage required to drive the valve.

In order to attain the aforementioned object, the present invention is also directed to an image recording apparatus, comprising: a liquid ejection head having nozzles which eject a liquid toward a recording medium; and the liquid supply apparatus as defined in claim 3 which supplies the liquid to the liquid ejection head.

In order to attain the aforementioned object, the present invention is also directed to a liquid supply method, comprising: a voltage control step of controlling voltage applied to an actuator of a valve which is arranged in a liquid supply flow channel connected to a liquid ejection head and opens and closes in accordance with the voltage applied to the actuator, to gradually change the voltage applied to the actuator of the valve from an initial voltage to a final voltage; a pressure measurement step of measuring pressure of a liquid inside the liquid supply flow channel; and an adjustment step of adjusting at least one of the initial voltage applied to the actuator of the valve and an amount of change per unit time of the voltage applied to the actuator of the valve, in accordance with a measurement value of the pressure obtained in the pressure measurement step.

Preferably, in the adjustment step, the amount of change per unit time of the voltage applied to the actuator of the valve is decreased when an amount of variation in the pressure before and after the voltage is applied to the actuator of the valve is larger than a prescribed value.

Preferably, in the adjustment step, the initial voltage applied to the actuator of the valve is decreased when a time from application of the voltage to the actuator of the valve until detection of variation in the pressure is shorter than a prescribed period.

Preferably, in the adjustment step, the initial voltage applied to the actuator of the valve is decreased when a time from application of the voltage to the actuator of the valve until detection of variation in the pressure is shorter than a prescribed period and an amount of variation in the pressure before and after the voltage is applied to the actuator of the valve is larger than a prescribed value.

According to the present invention, pressure variation in liquid inside the flow channel caused by the operation of the valve is suppressed, and furthermore defective operation of the valve arranged in the liquid supply flow channel can be eliminated.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a diagram showing a schematic view of an image recording apparatus (inkjet recording apparatus) according to a first embodiment of the present invention;

FIG. 2 is a diagram showing an ink supply channel for supplying ink from an ink storing and loading unit to a liquid ejection head;

FIG. 3 is a partial perspective plan diagram showing a nozzle surface and flow channel of the liquid ejection head;

FIG. 4 is a cross-sectional view along line 4-4 in FIG. 3;

FIG. 5 is a block diagram showing the control system of the inkjet recording apparatus in the first embodiment;

FIG. 6 is a graph showing a drive pulse waveform for driving valves;

FIG. 7 is a graph showing the relationship between the amount of temporal change (gradient) of the voltage applied to the valves, and the pressure variation in the ink inside main supply and return pipes;

FIG. 8 is a diagram showing ink supply and return tubes according to a second embodiment of the present invention;

FIG. 9 is a block diagram showing the control system of the inkjet recording apparatus in the second embodiment;

FIG. 10 is a graph for describing a process for calculating the amount of change (gradient) of the voltage applied to the valves;

FIG. 11 is a graph for describing a process for calculating an initial value for the voltage applied to the valves; and

FIG. 12 is a flowchart showing a method of driving the valves in the second embodiment.

### DETAILED DESCRIPTION OF THE PREFERRED EMBODIMENTS

### First Embodiment

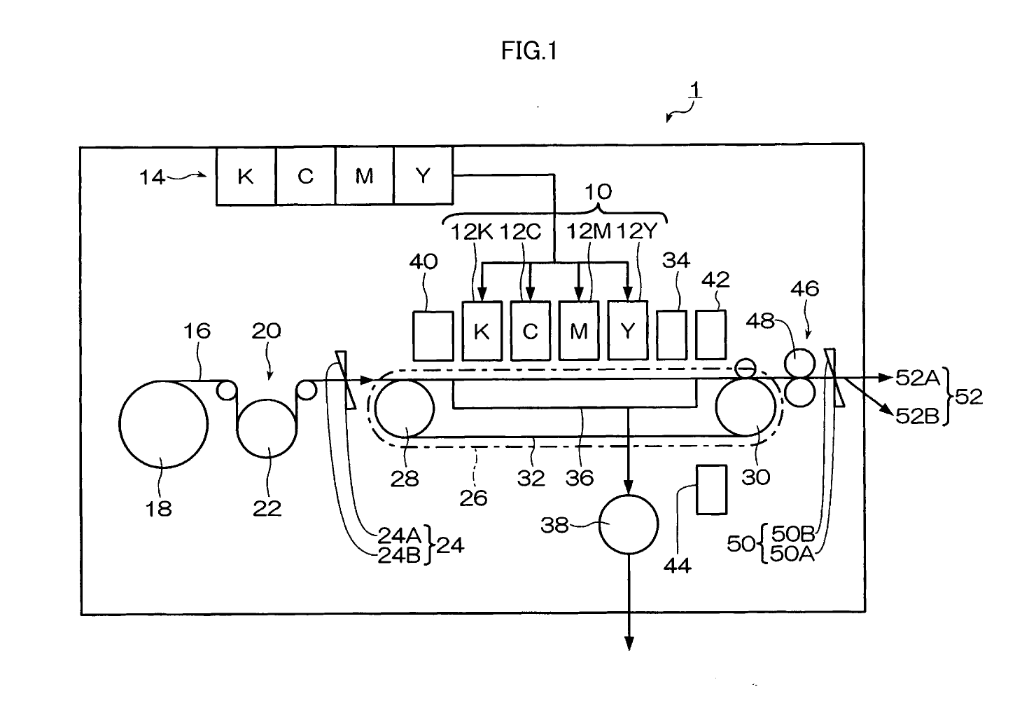

FIG. 1 is a diagram showing a schematic view of an image recording apparatus or inkjet recording apparatus according to a first embodiment of the present invention.

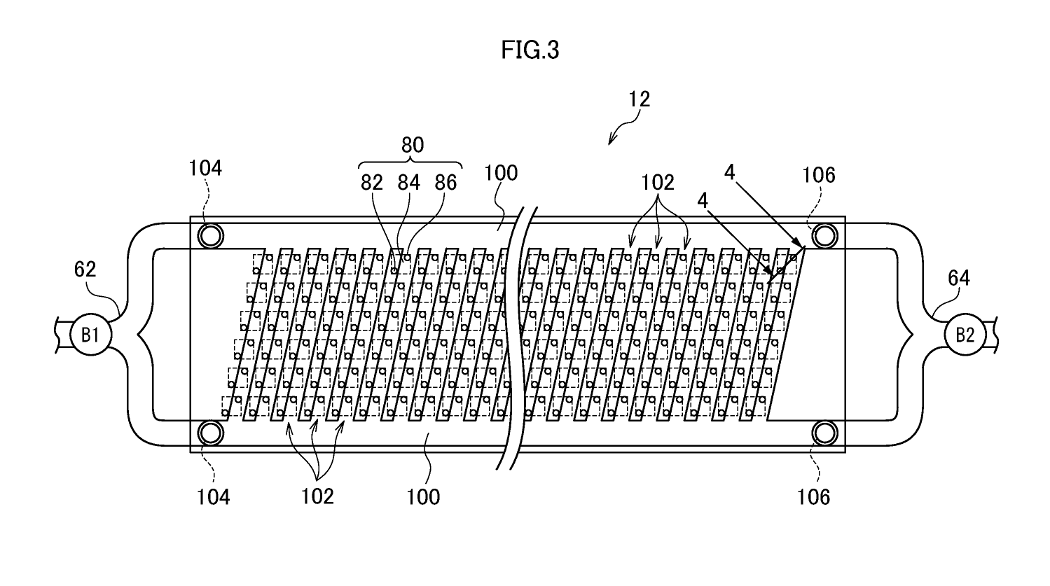

As shown in FIG. 1, the image recording apparatus 1 (inkjet recording apparatus) in the present embodiment has a print unit 10 including liquid ejection heads 12K, 12C, 12M and 12Y (hereinafter referred collectively to as the liquid ejection heads 12), and forms a color image by ejecting and depositing droplets of inks of four colors onto a printing surface of recording paper 16 from the print unit 10 on the basis of image data input from a host computer 120 (see FIG. 3).

Each liquid ejection head 12 is a full-line type liquid ejection head having a length corresponding to the maximum paper width of the recording paper 16, and is arranged in a direction (the main scanning direction (X direction)) that is perpendicular to a paper conveyance direction (sub-scanning direction (Y direction)). The liquid ejection heads 12K, 12C, 12M and 12Y respectively eject inks of four colors of black (K), cyan (C), magenta (M) and yellow (Y).

An ink storing and loading unit 14 stores the inks of the four colors of K, C, M and Y. The inks stored in the ink storing and loading unit 14 are supplied to the liquid ejection heads 12 through ink supply channels. The ink colors and the number of colors are not limited to the standard four colors of K, C, M, Y described above.

A paper supply unit 18 supplies the recording paper 16 to the print unit 10. The paper supply unit 18 is provided with a magazine for roll paper (continuous paper). It is also possible to provide a plurality of magazines having different paper widths and paper qualities, for example. Furthermore, it is also possible to provide a cassette in which cut sheets of paper are loaded.

A decurling unit 20 removes curl in the recording paper 16 by heating the recording paper 16 which is conveyed out from the paper supply unit 18, by means of a heating drum 22. Desirably, the heating temperature is controlled in such a manner that the printing surface is curled slightly outwards in the decurling process.

A cutter 24 includes a fixed blade 24A arranged on the rear surface side of the printing surface of the recording paper 16 and a circular blade 24B arranged on the printing surface side. The recording paper 16 conveyed from the paper supply unit 18 is cut to a desired size by the cutter 24. The recording paper 16 decurled in the decurling unit 20 and cut with the cutter 24 is conveyed to a suction belt conveyance unit 26.

The suction belt conveyance unit 26 includes two rollers 28 and 30, and an endless belt 32, which is wound about the rollers 28 and 30. The belt 32 is driven in the clockwise direction in FIG. 1, by the drive force of a motor (not shown) being transmitted to at least one of the rollers 28, 30, whereby the recording paper 16 held on the surface of the belt 32 is conveyed from left to right in FIG. 1.

The rollers 28 and 30 and the belt 32 are arranged in such a manner that the portion of the belt 32 that opposes the nozzle faces of the liquid ejection heads 12K, 12C, 12M and 12Y of the print unit 10 and the sensor face of a print determination unit 34 becomes flat.

The width of the belt 32 is broader than the width of the recording paper 16. A plurality of suction holes (not illustrated) are formed in the surface of the belt 32. A suction chamber 36 is arranged at a position opposing the nozzle faces of the print unit 10 and the sensor face of the print determination unit 34, on the inner side of the belt 32. The suction chamber 36 is set to a negative pressure by a fan 38. By this means, the recording paper 16 is held by suction on the surface of the belt 32.

A heating unit 40 heats the recording paper 16 before printing in order to shorten the time until drying from the deposition of the ink onto the recording paper 16. For the heating unit 40, it is possible to use a heating fan which heats the recording paper 16 by blowing heated air onto the recording paper 16, for example.

The print determination unit 34 includes an image sensor for capturing an image of the ink droplet deposition results produced by the print unit 10. The print determination unit 34 is constituted of a line sensor having a row of photoreceptor elements which is wider than the ink ejection width (image recording width) of the liquid ejection heads 12K, 12C, 12M and 12Y. For the print determination unit 34, it is also possible to use an area sensor, for example.

A post-drying unit 42 is a device which dries the printing surface of the recording paper 16. A heating fan, for example, is used as the post-drying unit 42.

A belt cleaning unit 44 removes ink that has adhered to the belt 32. The method of cleaning the belt 32 can employ, for example, a method which nips the belt with a brush roller or water absorbing roller, or the like, or an air blower method which blows clean air onto the belt 32.

A heat and pressure application unit 46 is a device for controlling the glossiness of the surface of the image printed on the recording paper 16. The heat and pressure application unit 46 is arranged after the post-drying unit 42, and pressure is applied to the printing surface by a pressing roller 48 having a prescribed undulating shape in the surface thereof, while heating the printing surface, thereby transferring the undulating shape to the image surface.

The recording paper 16 (printed item) on which an image has been printed as described above is output from the paper output unit 52. The inkjet recording apparatus 1 in the present embodiment includes a sorting device (not shown) which switches the paper output path in order to sort and selectively send, to respective paper output units 52A and 52B, a printed item on which an image for printing is printed, and a printed item on which a test pattern for print result determination is printed.

If the main image and the test print are formed simultaneously in aligned fashion on the recording paper 16, then the portion of the test print is cut off by a cutter 50. The cutter 50 includes a fixed blade 50A and a circular blade 50B, similarly to the cutter 24 described above.

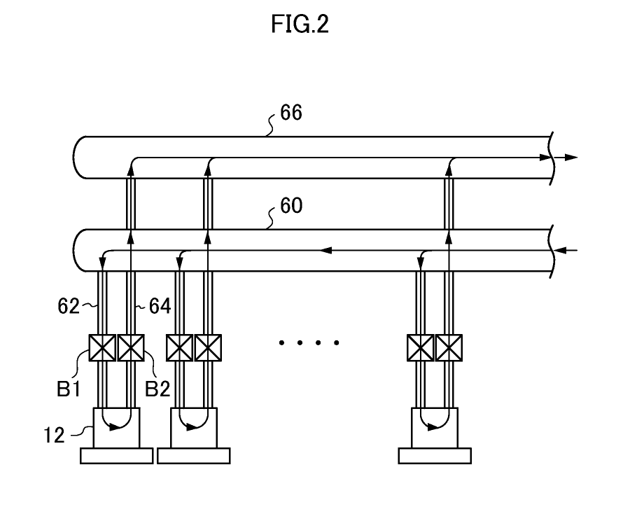

FIG. 2 is a diagram showing an ink supply channel for supplying the ink from the ink storing and loading unit 14 to the liquid ejection heads 12.

As shown in FIG. 2, the liquid ejection heads 12 are connected respectively to the ink storing and loading unit 14 through a main supply tube 60, a distributary supply tube 62, a tributary return tube 64, and a main return tube 66.

Valves B1 and B2 are arranged respectively in the distributary supply tube 62 and the tributary return tube 64. Each of the valves B1 and B2 is a solenoid valve, which includes a solenoid as an actuator and a valve body that is driven by passing current through the solenoid. The valves B1 and B2 control the supply of the liquid to the liquid ejection heads 12 and the return of the liquid from the liquid ejection heads 12. The valves B1 and B2 are latch valves which open and close in accordance with the direction of the applied current.

The ink supplied from the ink storing and loading unit 14 by a pump (not shown) is fed to the distributary supply tubes 62 through the main supply tube 60. When recording an image, both of the valves B1 and B2 are opened, and the ink supplied from the ink storing and loading unit 14 to the distributary supply tubes 62 flows through the liquid ejection heads 12 to the tributary return tubes 64. The ink sent to the tributary return tubes 64 flows to the main return tube 66 and is returned to the ink storing and loading unit 14 after removing impurities (solid material in the ink solution, and the like) by means of a filter (not shown).

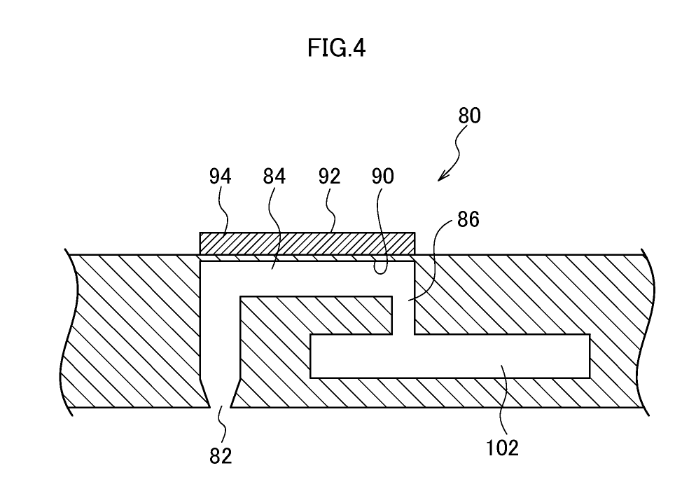

FIG. 3 is a partial perspective plan diagram showing the nozzle surface and the flow channels in the liquid ejection head 12, and FIG. 4 is a cross-sectional diagram along line 4-4 in FIG. 3.

As shown in FIG. 3, a plurality of liquid ejection elements 80 are arranged in a two-dimensional matrix configuration in the nozzle surface of the liquid ejection head 12. Each liquid ejection element 80 includes a nozzle 82, a pressure chamber 84, and an ink supply port 86. The nozzles 82 of the liquid ejection elements 80 are exposed on the nozzle surface of the liquid ejection head 12.

As shown in FIG. 3, the liquid ejection head 12 has an ink supply system which includes common main flow channels 100, common branch flow channels 102, inlet ports 104, outlet ports 106, and the valves B1 and B2.

The two common main flow channels 100 are arranged, in upper and lower positions in FIG. 3, on either side of a region where the liquid ejection elements 80 are arranged. The common main flow channels 100 are arranged following the main scanning direction, for example. The inlet ports 104 and the outlet ports 106 are arranged at the ends of the common main flow channels 100, and the inlet ports 104 and the outlet ports 106 are respectively connected to the distributary supply tube 62 and the tributary return tube 64.

The common branch flow channels 102 are arranged in a plurality of columns in the main scanning direction of the pressure chambers 84 of the liquid ejection head 12, and are connected to the main flow channels 100. Furthermore, the common branch flow channels 102 are connected to the ink supply ports 86 of the pressure chambers 84.

As shown in FIG. 4, the pressure chamber 84 of each liquid ejection element 80 is connected to the common branch flow channel 102 through the ink supply port 86. The common branch flow channels 102 are connected to the distributary supply tube 62 and the tributary return tube 64 through the common main flow channels 100, and the ink supplied from the ink storing and loading unit 14 is thereby supplied to the pressure chamber 84 through the common branch flow channel 102.

A diaphragm 90, which also serves as a common electrode, is formed on a portion of the upper surface of the pressure chamber 84 in FIG. 4. A piezoelectric element 94 having an individual electrode 92 is bonded to the diaphragm 90. When a drive voltage is applied to the individual electrode 92, the piezoelectric element 94 deforms, the volume of the pressure chamber 84 changes, and the ink in the pressure chamber 84 is ejected from the nozzle 82. When the piezoelectric element 94 returns to its original position after ejecting ink, the pressure chamber 84 is replenished with new ink from the common branch flow channel 102 through the ink supply port 86.

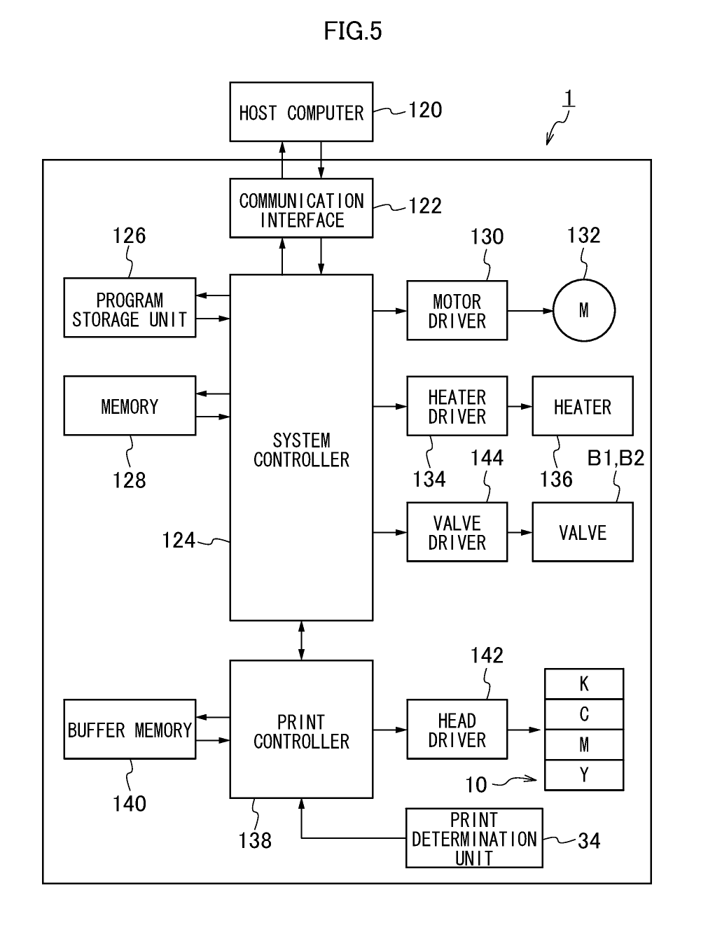

FIG. 5 is a block diagram showing the control system of the inkjet recording apparatus 1 according to the first embodiment of the present invention.

A system controller 124 is a control unit which controls the respective units of the inkjet recording apparatus 1. The system controller 124 includes a central processing unit (CPU) and peripheral circuits, and the like, and controls communications with a host computer 120, and reading and writing of data from and to a memory 128, as well as generating control signals to control motors 132 and heaters 136.

A program storage unit 126 is a storage region in which control programs of various types are stored. For the program storage unit 126, it is possible to use, for example, a semiconductor memory, such as a ROM (Read Only Memory) or EEPROM (Electronically Erasable and Programmable Read Only Memory), or a magnetic medium, such as a hard disk.

The memory 128 is a storage device which includes a storage area for various data, and a work area for the system controller 124 to carry out calculations. For the memory 128, it is possible to use a semiconductor memory, such as a RAM (Random Access Memory), or a magnetic medium, such as a hard disk, for example.

A communication interface 122 is an interface for connecting communications with the host computer 120. For the communication interface 62, it is possible to employ a serial interface such as a USB, IEEE 1394, or the like, a parallel interface such as Centronics, a wireless network, an Ethernet, or the like. The image data input through the communication interface 122 is stored temporarily in the memory 128.

A motor driver 130 drives the motors 132 in accordance with a control signal input from the system controller 124, so as to transmit drive force to the rollers 28 and 30 of the suction belt conveyance unit 26, thereby controlling the conveyance of the recording paper 16.

A heater driver 134 controls heating of the various heaters 76 included in the decurling unit 20, the heating unit 40, the post-drying unit 42 and the heat and pressure application unit 46, and the like, in accordance with control signals input from the system controller 124.

A valve driver 144 controls the opening and closing of the valves B1 and B2 by controlling the voltage or current applied to the solenoids of the valves B1 and B2, in accordance with control signals input from the system controller 124.

The print controller 138 generates a print control signal (dot data) by performing prescribed signal processing on the image data which is stored temporarily in the memory 128, in accordance with control signals input from the system controller 124. The print controller 138 controls the ejection volume and ejection timing of the ink ejected from the liquid ejection heads 12K, 12C, 12M and 12Y of the print unit 10, by controlling the head driver 142 on the basis of the print control signal described above. Furthermore, the print controller 138 corrects the print control signal on the basis of the ink droplet ejection results obtained from the print determination unit 34. By this means, a desired dot size and dot arrangement are achieved.

A buffer memory 140 is a storage apparatus including a work area for use by the print controller 138 in processing the image data.

### <Method of Driving Valves>

Next, a method of driving the valves according to the present embodiment is described.

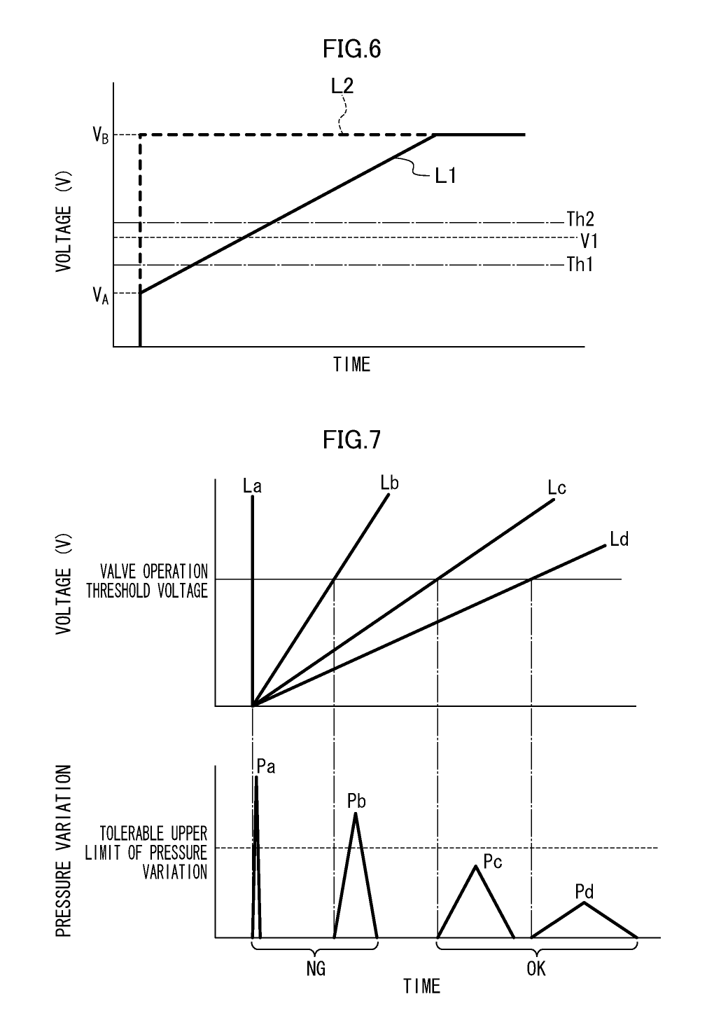

FIG. 6 is a graph showing a drive pulse waveform for driving the valves B1 and B2. In FIG. 6, the horizontal axis represents time and the vertical axis represents voltage (V).

With reference to FIG. 6, a case is described in which, in order to reduce the pressure variation when operating the valves B1 and B2, the valves are driven by the minimum voltage necessary to drive the valves (hereinafter referred to as a “valve drive threshold voltage Vth”). The valve drive threshold voltage Vth can vary with the properties of the valves. Furthermore, the valve drive threshold voltage Vth can vary with the temperature of the use environment of the valves (for example, the ink temperature) or with change over time. Consequently, if a uniform voltage V1 is applied to a plurality of valves, a valve having a valve drive threshold voltage Vth of Th1 (<V1) operates to open or close, but a valve having a valve drive threshold voltage Vth of Th2 (>V1) does not operate to open or close. Therefore, a problem arises in that the valves cannot be stably driven.

On the other hand, if the applied voltage V is V_{B} (>>Th1, Th2) as indicated with a broken line L2 in FIG. 6, then although it is possible to stably drive the valves to open or close, the pressure variation becomes large.

In the present embodiment, the applied voltage V is changed gradually from an initial voltage V_{A} to the final voltage V_{B}, as indicated with a solid line L1 in FIG. 6. Here, the initial voltage V_{A} and the final voltage V_{B} are determined by measuring the valve drive threshold voltages Vth or the temporal changes thereof, for a plurality of valves of the same type, and finding the minimum and maximum measurement voltages Vmin and Vmax of the valve drive threshold voltages Vth. In the present embodiment, V_{A}<Vmin and V_{B}>Vmax. It is desirable that the initial voltage V_{A} and the final voltage V_{B} are respectively set to V_{A}≦0.75×Vmin and V_{B}≧1.20×Vmax, in order that the valve drive threshold voltages Vth of the plurality of valves and the valve drive threshold voltages after temporal change are situated between the initial voltage V_{A} and the final voltage V_{B}. The initial voltage V_{A} and the final voltage V_{B} set as described above are stored in the program storage unit 126.

Next, the method of calculating the amount of temporal change (gradient) of the voltage applied to the valves B1 and B2 is described.

FIG. 7 is a graph showing the relationship between the amount of temporal change (gradient) of the voltage applied to the valves B1 and B2 and the pressure variation in the ink inside the main supply and return tubes 60 and 66. In FIG. 7, the horizontal axis represents time and the vertical axis represents the amount of pressure variation.

As shown in FIG. 7, the greater the amount of change in the voltage per unit time (amount of temporal change, gradient), the larger the amount of variation in the pressure of the ink inside the main supply and return tubes 60 and 66. In the present embodiment, the amount of temporal change in the voltage and the amount of pressure variation are measured in advance, and the range of the amount of temporal change in the voltage (between Lc and Ld in FIG. 7) where the amount of pressure variation is not larger than the tolerable upper limit of the pressure variation are determined. The amount of temporal change of the voltage thus determined is stored in the program storage unit 126.

Here, the upper tolerable limit of the pressure variation is the threshold value of pressure variation that avoids the occurrence of entrapping of air bubbles or bleeding of ink through the nozzles 82, and this value is found experimentally on the basis of the composition of the inkjet recording apparatus 1 (for example, the liquid ejection head 12, the diameters of the main supply tube 60, the distributary supply tube 62, the tributary return tube 64, the main return tube 66, the common main flow channels 100, the common branch flow channels 102, and the like).

When driving the valves, the system controller 124 controls the voltage applied to the valves B1 and B2 by reading out the initial voltage V_{A}, the final voltage V_{B} and the amount of temporal change in the voltage, from the program storage unit 126. Thus, the pressure variation in the liquid inside the flow channels caused by the operation of the valves is suppressed, and furthermore defective operations of the valves arranged in the flow channels can be eliminated.

### Second Embodiment

Next, a second embodiment of the present invention is described. The description of the composition which is similar to that of the first embodiment described above is omitted here.

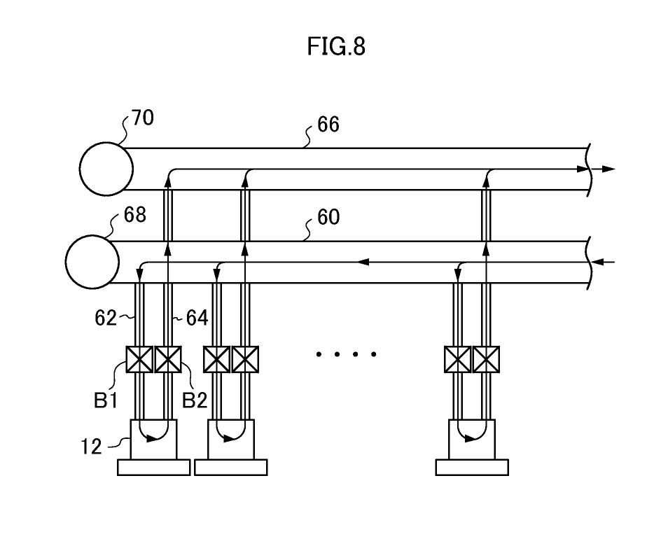

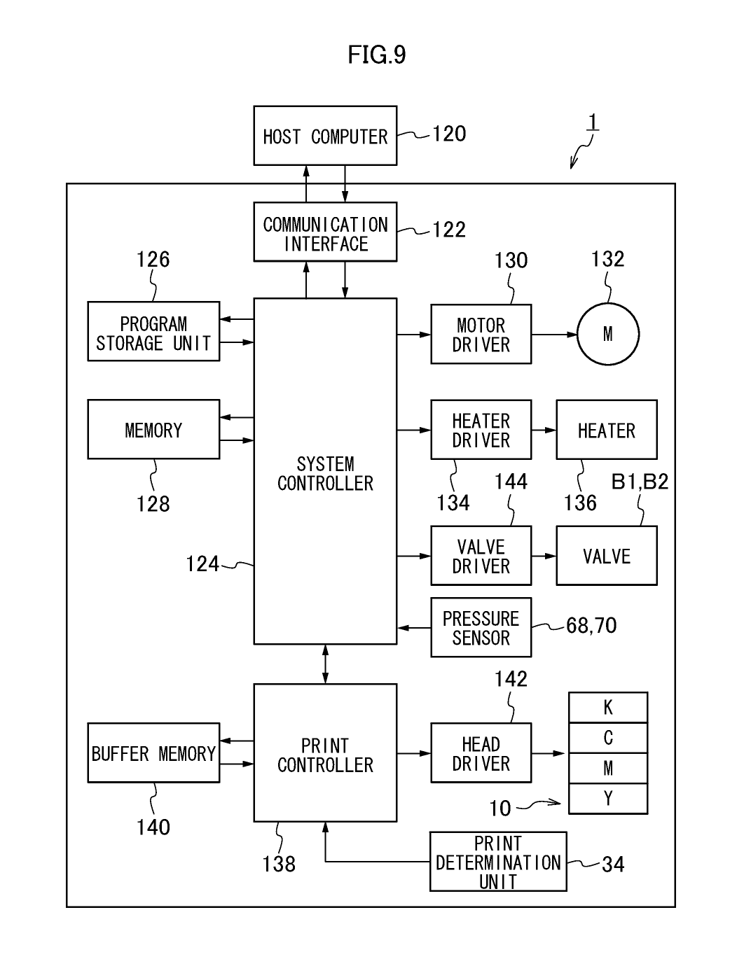

FIG. 8 is a diagram showing the ink tubes in the second embodiment of the present invention, and FIG. 9 is a block diagram showing a control system of the inkjet recording apparatus 1 in the second embodiment of the present invention.

As shown in FIG. 8, in the present embodiment, pressure sensors 68 and 70 are arranged respectively on the end portions of the main supply tube 60 and the main return tube 66. The pressure sensors 68 and 70 respectively measure the pressure of the ink inside the main supply tube 60 and the main return tube 66. It is also possible to arrange the pressure sensors 68 and 70 in the distributary supply tube 62 and the tributary return tube 64.

The pressure sensors 68 and 70 measure the pressure inside the main supply tube 60 and the main return tube 66, at prescribed time intervals, and output signals indicating the measured pressure to the system controller 124. The system controller 124 adjusts the initial voltage and the amount of change (gradient) of the voltage applied to the valves B1 and B2, on the basis of the variation in the pressure before and after the voltage is applied to the valves B1 and B2, respectively.

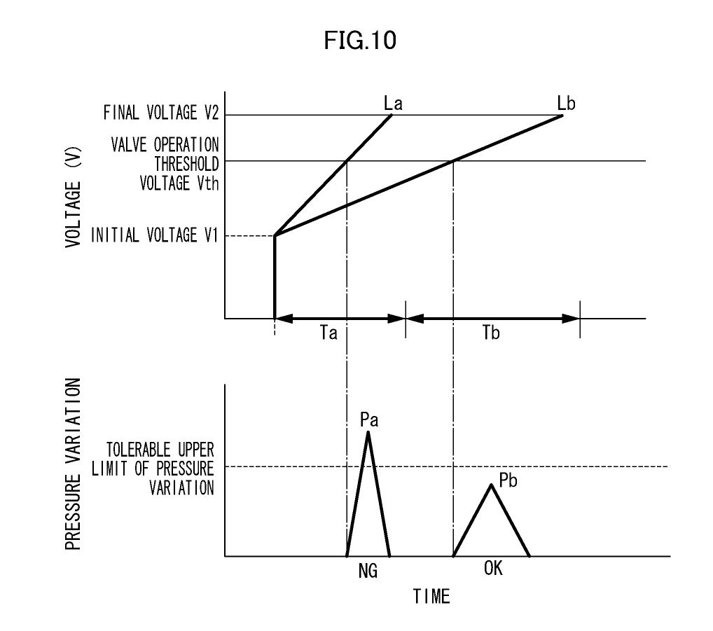

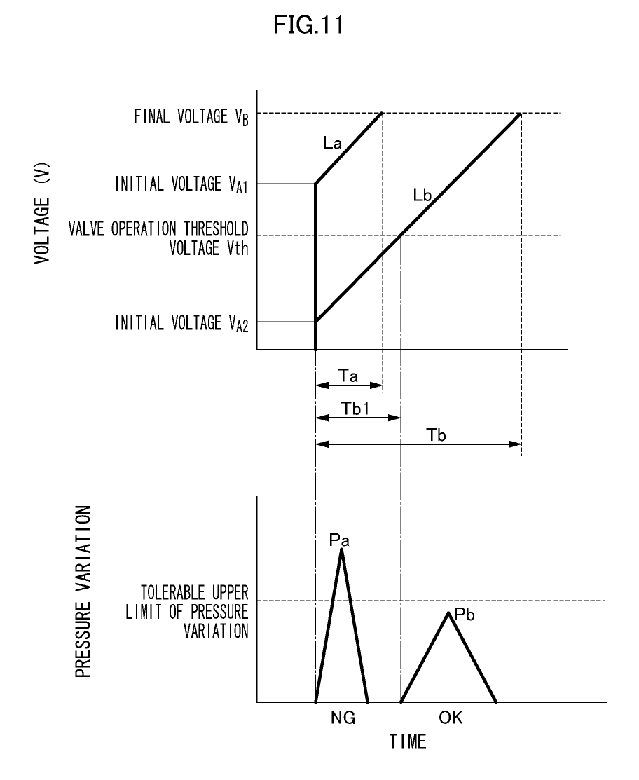

FIG. 10 is a graph for describing a process for calculating the amount of change (gradient) of voltage applied to the valves B1 and B2.

As shown in FIG. 10, if the applied voltage is changed as indicated with a line La, then it is found that the pressure variation before and after the voltage is applied exceeds the tolerable upper limit of pressure variation, as indicated with a line Pa. In this case, the system controller 124 reduces the amount of change in the voltage, so as to follow a line Lb. Thereby, it is possible to make the pressure variation before and after the voltage is applied, not larger than the tolerable upper limit of the pressure variation.

FIG. 11 is a graph for describing a process for calculating the initial voltage applied to the valves B1 and B2.

As shown in FIG. 11, if the applied voltage is changed as indicated with a line La, where the initial value V_{A1} of the applied voltage is over the valve operation threshold voltage Vth, then the valves B1 and B2 suddenly open immediately after the voltage is applied, and the pressure sensors 68 and 70 detect that the amount of pressure variation is greater than a prescribed value (the reference value for detection of pressure variation). Moreover, in the line Pa shown in FIG. 11, the amount of pressure variation before and after the voltage is applied exceeds the tolerable upper limit of the pressure variation.

The system controller 124 lowers the initial value of the applied voltage by a prescribed value dV (for example, dV=1.0 V) below V_{A1}, thus changing the initial voltage to V_{A2}, if the pressure variation in at least one of the pressure sensors 68 and 70 is detected within a prescribed time period Tth from the start of voltage application (for example, within a Tth value of approximately 10 milliseconds). In so doing, the time from the start of application of voltage until reaching the valve drive threshold voltage Vth is lengthened to Tb1 as indicated with a line Lb, and the valves B1 and B2 open gradually as the applied voltage value increases. Thus, it is possible to make the time from the start of application of voltage until the occurrence of pressure variation equal to or longer than the prescribed time period Tth, and it is possible to prevent the pressure variation immediately after the start of applying voltage from exceeding the tolerable upper limit of pressure variation as indicated with a line Pb.

If a pressure variation is detected within the prescribed time period of Tth immediately after application of voltage, even if the initial value of the applied voltage has been lowered as described above, then the initial value of the applied voltage is lowered further by dV. By subsequently repeating the actions of detecting pressure variation and changing the initial value of the applied voltage, it is possible to set the initial value of the applied voltage appropriately.

The values of Tth and dV given above are examples, and are determined in accordance with the composition of the inkjet recording apparatus 1.

In the present embodiment, the initial value of the applied voltage is lowered if a pressure variation is detected within the prescribed time period Tth from the start of application of voltage; however, it is also possible to lower the initial value of the applied voltage if a pressure variation is detected within the prescribed time period Tth from the start of application of voltage and if the amount of pressure variation detected by at least one of the pressure sensors 68 and 70 is greater than the tolerable upper limit of pressure variation.

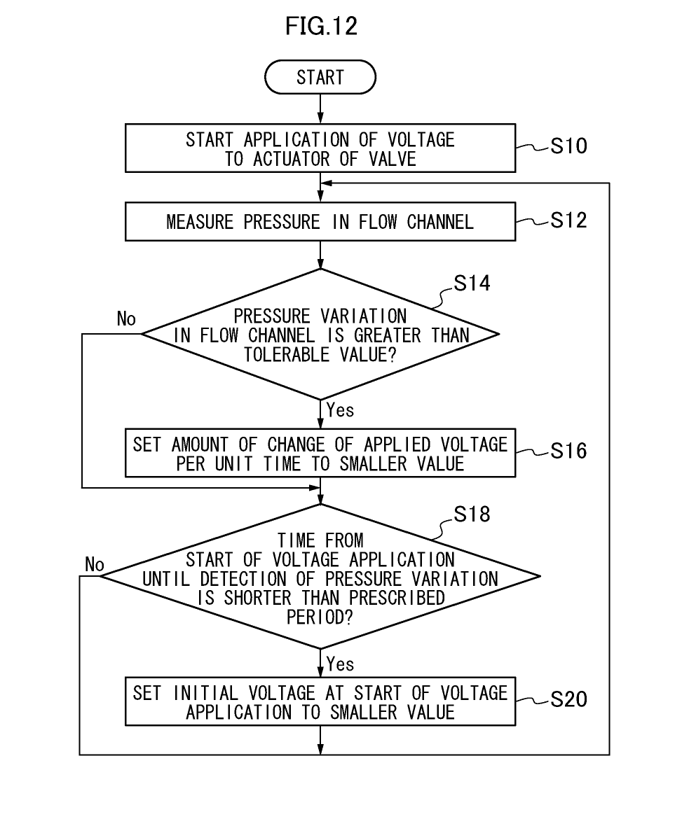

Next, a method for driving valves in the present embodiment is described. FIG. 12 is a flowchart showing a method of driving valves according to the second embodiment of the present invention.

Firstly, as shown in FIG. 12, the system controller 124 starts application of voltage to the valves B1 and B2 on the basis of the initial voltage V_{A}, the final voltage V_{B} and the amount of temporal change in the voltage which are read out from the program storage unit 126 (step S10). When the application of voltage to the valves B1 and B2 is started, the pressure sensors 68 and 70 measure the pressure of the ink inside the main supply and return tubes 60 and 66, respectively, and output the signals indicating the measured pressure to the system controller 124 (step S12).

Thereupon, the system controller 124 judges whether or not the pressure variation inside the flow channels is larger than the tolerable upper limit of pressure variation (tolerance value) (step S14). If the variation in the pressure inside the flow channels is larger than the tolerable upper limit of pressure variation (Yes at step S14), then the system controller 124 decreases the amount of temporal change in the applied voltage (step S16). On the other hand, if the variation in the pressure inside the flow channels is not larger than the tolerable upper limit of pressure variation (No at step S14), then the procedure advances to step S18.

Thereupon, the system controller 124 judges whether or not the time from the start of voltage application until the detection of pressure variation is shorter than the prescribed time period Tth (step S18). If the time from the start of voltage application until the detection of pressure variation is shorter than the prescribed time period Tth (Yes at step S18), then the voltage value at the start of voltage application (i.e., the initial voltage) is lowered by the prescribed value dV (step S20). On the other hand, if the time from the start of voltage application until the detection of pressure variation is not shorter than the prescribed time period Tth (Yes at step S18), then the procedure returns to the step S12.

By repeating the steps S12 to S20 described above, the initial value V_{A} of the applied voltage and the amount of temporal change in the voltage are optimized.

According to the present embodiment, by monitoring the pressure of the ink inside the main supply and return tubes 60 and 66, and altering the initial value V_{A} of the applied voltage and the amount of temporal change in the voltage, the pressure variation in the liquid inside the flow channels caused by operation of the valves is suppressed, and furthermore defective operation of the valves arranged in the flow channels can be eliminated.

In the embodiments described above, the voltage is linearly changed; however, it is also possible to change the voltage stepwise or non-linearly. If the voltage is changed non-linearly, then the amount of temporal change in the voltage should have a gradient determined by the steps described above, or less.

Furthermore, in the present embodiment, the voltage (V) applied to the solenoids of the valves B1 and B2 are controlled; however, it is also possible to control the current (A) instead of the voltage (V).

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A liquid supply apparatus, comprising:
a liquid supply flow channel which is connected to a liquid ejection head;
a valve which is arranged in the liquid supply flow channel and opens and closes in accordance with voltage applied to an actuator of the valve; and
a voltage control device which controls the voltage applied to the actuator of the valve, and gradually changes the voltage applied to the actuator of the valve from an initial voltage that is lower than a threshold voltage required for the valve to operate to a final voltage that is higher than the threshold voltage.

2. An image recording apparatus, comprising:
a liquid ejection head having nozzles which eject a liquid toward a recording medium; and
the liquid supply apparatus as defined in claim 1 which supplies the liquid to the liquid ejection head.

3. A liquid supply apparatus, comprising:
a liquid supply flow channel which is connected to a liquid ejection head;
a valve which is arranged in the liquid supply flow channel and opens and closes in accordance with voltage applied to an actuator of the valve;
a voltage control device which controls the voltage applied to the actuator of the valve, and gradually changes the voltage applied to the actuator of the valve from an initial voltage to a final voltage;
a pressure measurement device which measures pressure of a liquid inside the liquid supply flow channel; and
an adjustment device which adjusts at least one of the initial value of the voltage applied to the actuator of the valve and an amount of change per unit time of the voltage applied to the actuator of the valve, in accordance with a measurement value of the pressure obtained by the pressure measurement device.

4. The liquid supply apparatus as defined in claim 3, wherein the adjustment device decreases the amount of change per unit time of the voltage applied to the actuator of the valve when an amount of variation in the pressure before and after the voltage is applied to the actuator of the valve is larger than a prescribed value.

5. The liquid supply apparatus as defined in claim 3, wherein the adjustment device decreases the initial voltage applied to the actuator of the valve when a time from application of the voltage to the actuator of the valve until detection of variation in the pressure is shorter than a prescribed period.

6. The liquid supply apparatus as defined in claim 3, wherein the adjustment device decreases the initial voltage applied to the actuator of the valve when a time from application of the voltage to the actuator of the valve until detection of variation in the pressure is shorter than a prescribed period and an amount of variation in the pressure before and after the voltage is applied to the actuator of the valve is larger than a prescribed value.

7. An image recording apparatus, comprising:
a liquid ejection head having nozzles which eject a liquid toward a recording medium; and
the liquid supply apparatus as defined in claim 3 which supplies the liquid to the liquid ejection head.

8. A liquid supply method, comprising:
a voltage control step of controlling voltage applied to an actuator of a valve which is arranged in a liquid supply flow channel connected to a liquid ejection head and opens and closes in accordance with the voltage applied to the actuator, to gradually change the voltage applied to the actuator of the valve from an initial voltage to a final voltage;
a pressure measurement step of measuring pressure of a liquid inside the liquid supply flow channel; and
an adjustment step of adjusting at least one of the initial voltage applied to the actuator of the valve and an amount of change per unit time of the voltage applied to the actuator of the valve, in accordance with a measurement value of the pressure obtained in the pressure measurement step.

9. The liquid supply method as defined in claim 8, wherein in the adjustment step, the amount of change per unit time of the voltage applied to the actuator of the valve is decreased when an amount of variation in the pressure before and after the voltage is applied to the actuator of the valve is larger than a prescribed value.

10. The liquid supply method as defined in claim 8, wherein in the adjustment step, the initial voltage applied to the actuator of the valve is decreased when a time from application of the voltage to the actuator of the valve until detection of variation in the pressure is shorter than a prescribed period.

11. The liquid supply method as defined in claim 8, wherein in the adjustment step, the initial voltage applied to the actuator of the valve is decreased when a time from application of the voltage to the actuator of the valve until detection of variation in the pressure is shorter than a prescribed period and an amount of variation in the pressure before and after the voltage is applied to the actuator of the valve is larger than a prescribed value.
